(19) United States
(12) Patent Application Publication
(10) Pub. No.: US 2025/0282585 A1
(43) Pub. Date: Sep. 11, 2025

(54) SYSTEM ENABLING AUXILIARY EQUIPMENT ON TRACTOR-LIKE VEHICLES

(71) Applicants: Scott Rosenthal, Leggett, CA (US); Melissa Rosenthal, Leggett, CA (US)

(72) Inventors: Scott Rosenthal, Leggett, CA (US); Melissa Rosenthal, Leggett, CA (US)

(21) Appl. No.: 18/599,899

(22) Filed: Mar. 8, 2024

(51) Int. Cl. B66D 3/20; B62D 65/16

(52) U.S. Cl. CPC B66D 3/20; B62D 65/16

(57) ABSTRACT

The system of the present invention enhances the utility of tractor-like vehicles such as excavators for land management and forest fire prevention through the integration of auxiliary equipment. This system comprises a securely attachable bracket designed to support a dual winch setup on the vehicle's frame, enabling a multifaceted operational approach without compromising the excavator's primary functions. The system is devised to optimize and expand on the excavator's capabilities, introducing a versatile solution for improving land management practices and contributing to effective forest fire prevention strategies, thereby representing a significant advancement in the field of environmental conservation and machinery utility.

### CROSS-REFERENCE TO RELATED APPLICATIONS

N/A

### BACKGROUND OF THE INVENTION

### 1. Field of the Invention

The present invention generally relates to wildfire prevention equipment but more particularly to a system enabling auxiliary equipment on tractor-like vehicles.

### 2. Description of Related Art

Wildfires are an inherent aspect of many ecosystems, but their destructive potential escalates dramatically in the presence of excessive underbrush and deadwood. These elements act as fuel, intensifying fires to levels that can devastate wildlife, human life, property, and significantly contribute to air pollution and climate change. The removal of underbrush around trees is thus a critical preventive measure in wildfire management and forest health preservation.

Historically, several methods have been employed to manage underbrush, each with its unique set of challenges and limitations. Manual removal, for instance, involves the labor-intensive use of hand tools to clear small areas of underbrush, proving inefficient for larger landscapes. Mechanical clearing, on the other hand, utilizes heavy machinery to clear vast expanses but can lead to soil compaction and disrupt wildlife habitats, rendering it unsuitable for steep or inaccessible terrains. Controlled burns or prescribed burns are another method, where small, managed fires are set to mimic natural fire cycles and reduce the risk of larger wildfires. However, this approach demands specific weather conditions and carries inherent risks if not properly managed, alongside potential regulatory and public scrutiny. Lastly, chemical treatments involve applying herbicides to kill underbrush, posing risks to non-target species, water sources, and the broader ecosystem.

The proposed system enabling auxiliary equipment on tractor-like vehicles provides an improved solution for controlling underbrush as well as other suitable applications.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, an auxiliary equipment system for a tractor-like vehicle is provided, comprising a bracket configured for secure attachment to a frame of the tractor-like vehicle to support auxiliary equipment; and, wherein the bracket includes a platform configured to accommodate the auxiliary equipment, enhancing the operational capabilities of the tractor-like vehicle without altering its fundamental functions.

In one embodiment, the auxiliary equipment includes a first winch and a second winch, each winch being independently mountable on the platform on the bracket. In another embodiment, a first line associated with the first winch and a second line associated with the second winch are provided, wherein each line is configured for individual operation to move or pull objects. In yet another embodiment, the first and second lines are utilized in a dragline configuration, wherein the first and second lines are arranged to support dragging, lifting, and positioning of objects. In one embodiment, the first and second winches are positioned on the platform with the first winch elevated above the second winch.

In another aspect of the invention, a method for installing auxiliary equipment on a tractor-like vehicle is provided, comprising the steps of: identifying attachment points on a frame of the tractor-like vehicle for the installation of a bracket; securing the bracket to the frame via fastening elements; positioning a platform on the bracket to receive auxiliary equipment, wherein the auxiliary equipment is configured to extend the utility of the tractor-like vehicle for additional operational tasks.

In one embodiment, a further step of installing a first winch and a second winch on the platform positioned on the bracket is provided, wherein each winch is equipped with a corresponding line for operational tasks. In one embodiment, the corresponding lines of the first winch and the second winch are utilized in a dragline configuration to support dragging, lifting, and positioning of objects.

In yet another aspect of the invention, a system for enhancing land management and forest fire prevention capabilities of an excavator, wherein the excavator equipped with a boom, an arm/dipper, a bucket, and a cab, wherein the excavator is configured to perform standard excavation operations, the system comprising: a bracket configured to be securely attachable to the frame of the excavator, wherein the bracket is configured to support auxiliary equipment without compromising the excavator's inherent functionalities; auxiliary equipment mounted on the bracket, including a first winch and a second winch, each winch being equipped with a respective first line and second line for operational tasks; and, wherein the boom of the excavator is adapted to facilitate a dragline configuration by providing an elevated point of attachment for the first and second lines, enabling the auxiliary equipment to extend the excavator's capabilities beyond excavation to include the dragging, lifting, and precise positioning of materials such as underbrush and debris, thereby leveraging the excavator's structural and operational characteristics to improve land management and contribute to forest fire prevention efforts.

In one embodiment, the first line of the first winch is configured to be anchored to a fixed location, providing a stable point of leverage that enhances the operational capacity of the dragline configuration, enabling more effective dragging, lifting, and positioning of materials by utilizing the fixed point to maximize control and force application during land management and forest fire prevention tasks. In another embodiment, the second line of the second winch is being utilized as the dragline for the manipulation and movement of materials, and a dump block is provided and connected to the second line and the first line, facilitating the controlled positioning of materials.

The foregoing has outlined rather broadly the more pertinent and important features of the present disclosure so that the detailed description of the invention that follows may be better understood and so that the present contribution to the art can be more fully appreciated. Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a tractor-like vehicle with auxiliary equipment installed according to an embodiment of the present invention.

FIG. 2 is a perspective view of a tractor-like vehicle with auxiliary equipment installed according to an embodiment of the present invention.

FIG. 3 is a detailed view of auxiliary equipment being installed on a tractor-like vehicle according to an embodiment of the present invention.

FIG. 4 is a perspective view of a tractor-like vehicle with auxiliary equipment during use according to an embodiment of the present invention.

### ETAILED DESCRIPTION OF THE INVENTION

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a system enabling auxiliary equipment on tractor-like vehicles.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure. The term “tractor-like vehicles” refers to any form of heavy machinery such as earthmoving tractors, including but not limited to excavators, bulldozers, backhoes, graders, skid-steers, or similar vehicles. The term “auxiliary equipment” refers to any supplementary components, systems, or devices that are designed to augment, support, or add functionality to a primary piece of machinery or equipment.

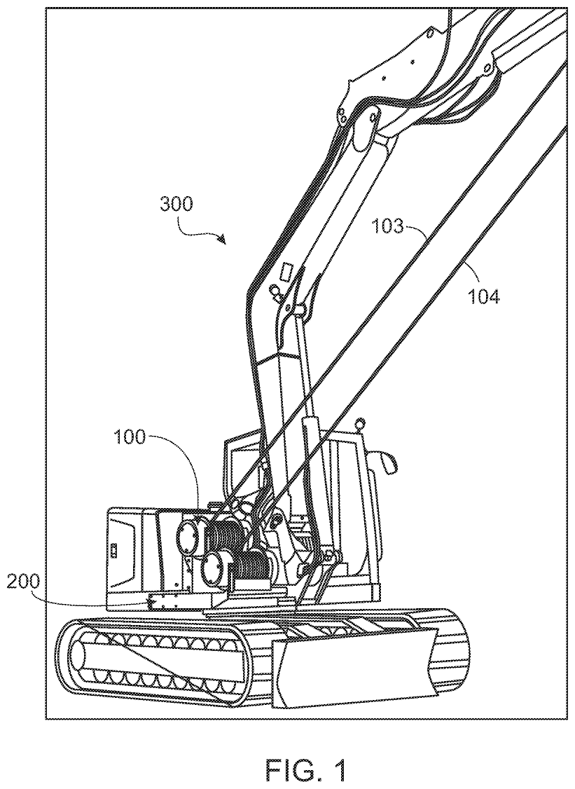

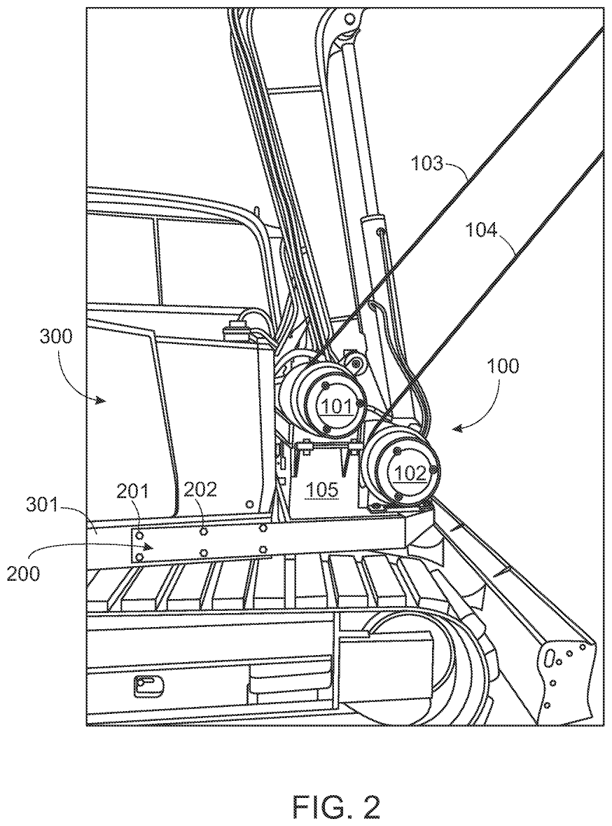

Referring now to FIGS. 1-2, various perspective views of a tractor-like vehicle 300 with auxiliary equipment 100 installed are illustrated. In the exemplary embodiment illustrated, the tractor-like vehicle 300 is an excavator, having a boom, arm/dipper, bucket, and cab. However, the tractor-like vehicle may be any tractor-like vehicle as well known in the art. A significant advantage of the present invention is its ability to augment the utility of the tractor-like vehicle through the incorporation of auxiliary equipment 100, thereby enhancing its functionality while preserving its original features and equipment. In the instant example, this means the tractor-like vehicle can employ both the auxiliary equipment 100 and its inherent components, such as the boom, arm, and bucket, as required.

In one embodiment, the system includes the tractor-like vehicle 300, exemplified by the excavator, which integrates a bracket 200 securely attached to the frame 301 of the vehicle via multiple fasteners 201/202. This bracket 200 serves as a foundational platform for the auxiliary equipment 100. Specifically, the auxiliary equipment 100 comprises a first winch 101 and a second winch 102. The first winch 101 is equipped with a first line 103, while the second winch 102 includes a second line 104, ensuring each winch operates with its distinct line. Some configurations include a pedestal platform 105 positioned on the bracket, which elevates the first winch 101 above the second winch 102, as prominently displayed in FIG. 2. This setup allows for the independent or combined operation of the first and second lines to pull or move objects, such as brush, enhancing the system's versatility in forest fire prevention efforts.

Incorporating a double winch system, particularly for removing underbrush and combustible materials, introduces an improved approach to mitigating wildfire risks. The adaptability and robustness of the double winch setup are paramount for maneuvering through the complex and often perilous terrains encountered in forested areas. This innovation significantly extends the capability to access and clear brush in otherwise inaccessible areas, such as steep inclines or densely vegetated regions, thereby broadening the scope and effectiveness of fire prevention measures.

The present invention enables selective clearing, a critical aspect for preserving the health and ecological balance of the forest. It ensures the removal of targeted, combustible underbrush while safeguarding mature trees and beneficial vegetation. This precision not only bolsters wildfire prevention efforts but also minimizes soil disturbance, an essential factor in preventing erosion, maintaining soil health, and conserving natural habitats, highlighting the environmental benefits of this approach.

Further details will explain how the double winch setup can be adapted for use as a dragline, improving the management and removal of underbrush with enhanced efficiency and control. This configuration enables the precise maneuvering and positioning of the dragline bucket, tool, hook, or similar tool which is crucial for targeted brush removal in sensitive or challenging-to-access forest areas, such as on steep slopes. Essentially, the invention allows any tractor-like vehicle to maintain its original functionality while incorporating the capabilities of a dragline excavator, a very useful feature considering the limitations of traditional dragline excavators in forested terrains. For instance, dragline excavators are much larger than other tractor-like vehicles and are not suitable for traversing heavily forested areas with dense trees, and steep and uneven slopes. Further, dragline excavators also have limitations on movement, with their typical “walking” method of movement would disrupt the soil causing further problems.

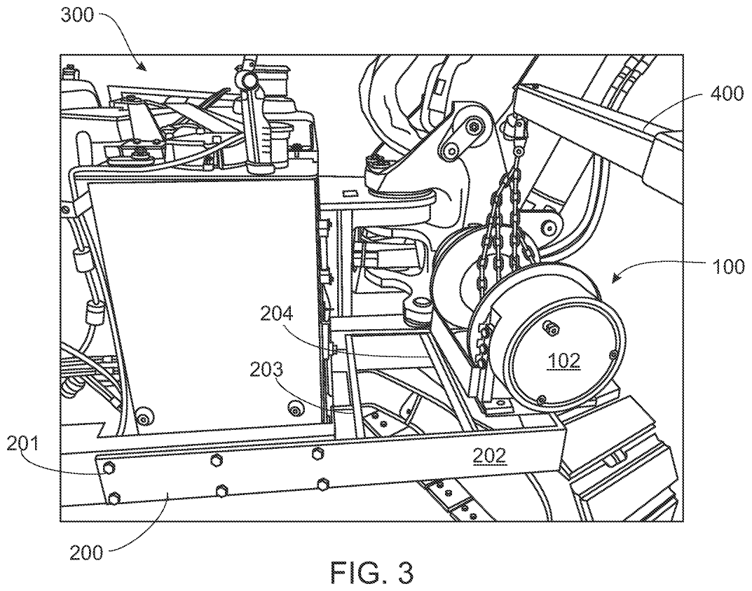

Referring now to FIG. 3, a detailed view of the auxiliary equipment 100 being installed on a tractor-like vehicle 300 is depicted. A floor crane 400, or a similar installation tool, facilitates the placement of the auxiliary equipment 100 on the bracket 200. As demonstrated, the second winch 102 is positioned on one end of the bracket, identified as 202, on a first platform or support member 204. Once the winch is positioned, it can be secured to the bracket 200 via fasteners. Similarly, the first winch can be positioned on an adjacent platform or support member 203, whether directly or atop a pedestal as illustrated in FIG. 2, then fastened to ensure the equipment is secure during use. The lines, if not previously installed, are carefully threaded through any necessary pulleys or guides on the equipment. Power and electrical for operating the equipment can be run to the control system in the cab of the vehicle for seamless operation.

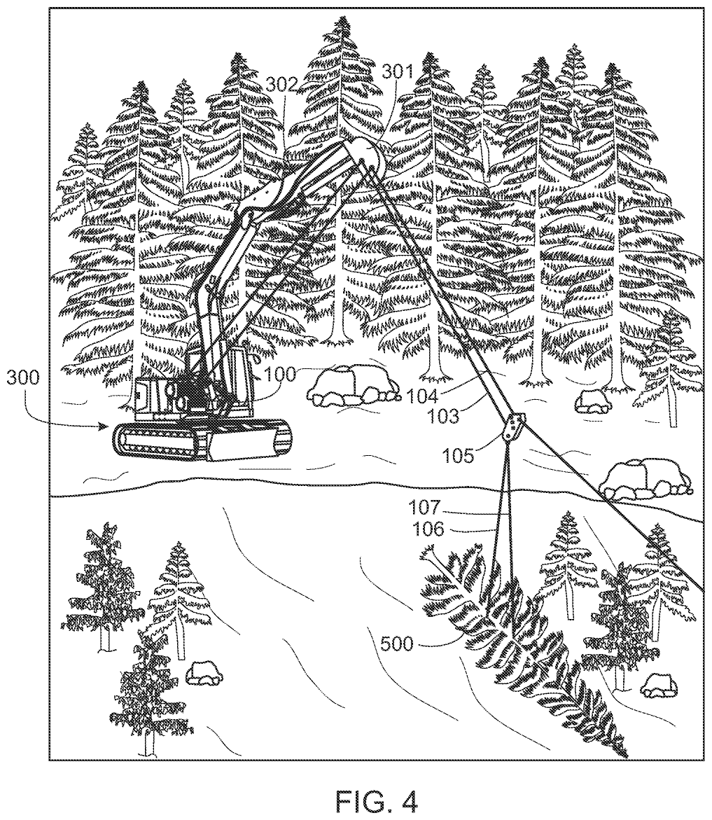

Referring now to FIG. 4, a perspective view of the tractor-like vehicle 300 with auxiliary equipment 100 during use is illustrated. In the exemplary embodiment illustrated, the first and second winch are being used in a dragline configuration, which includes the first and second line (103/104) being guided through a first and second pulley on the bucket 301 which is extending in a raised or elevated position via the boom or arm 302. In some embodiments, the pulleys may be attached to a mounting bracket or other element which may be fastened to the bucket during use. In some embodiments, a dump block 105 or similar pulley hook system is used to join the first and second line, to a third and fourth line 106/107 which may be used and configured to secure to load 500, such as a downed tree or brush in any manner known in the art. In this embodiment, the second line 104 becomes the hoist cable, wherein one end of the hoist cable is attached to a steady and fixed object such as a large tree positioned down the hill (not shown) in the embodiment illustrated in FIG. 4. The first line 103 becomes the drag cable and controls the movement of the dump block 105 or load 500. This enables an operator, positioned in the cab of the tractor-like vehicle 300, to move the load, such as a downed tree or underbrush, up the hill.

It is understood that the auxiliary equipment described herein represents just one potential configuration. Various other forms of auxiliary equipment can be adapted to the bracket to furnish the tractor-like vehicle with expanded utility without necessitating additional vehicles or machinery. Auxiliary equipment can be tailored to specific operational needs or industry requirements, ranging from manufacturing and construction to agriculture, environmental management, and beyond. It is characterized by its versatility and adaptability, allowing for seamless integration with existing systems to address a variety of tasks and challenges across different sectors. The design and implementation of auxiliary equipment are guided by the principle of enhancing the operational scope and performance of primary equipment without compromising its original functionality or requiring significant modifications.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

It should further be noted that throughout the entire disclosure, the labels such as left, right, front, back, top, bottom, forward, reverse, clockwise, counterclockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and etc. members throughout the disclosure (and in particular, claims) are not used to show a serial or numerical limitation but instead are used to distinguish or identify the various members of the group.

What is claimed is:

1. An auxiliary equipment system for a tractor-like vehicle, comprising:
a bracket configured for secure attachment to a frame of the tractor-like vehicle to support auxiliary equipment; and,
wherein the bracket includes a platform configured to accommodate the auxiliary equipment, enhancing the operational capabilities of the tractor-like vehicle without altering its fundamental functions.

2. The system of claim 1, wherein the auxiliary equipment includes a first winch and a second winch, each winch being independently mountable on the platform on the bracket.

3. The system of claim 2, further comprising a first line associated with the first winch and a second line associated with the second winch, wherein each line is configured for individual operation to move or pull objects.

4. The system of claim 3, wherein the first and second lines are utilized in a dragline configuration, wherein the first and second lines are arranged to support dragging, lifting, and positioning of objects.

5. The system of claim 3, wherein the first and second winches are positioned on the platform with the first winch elevated above the second winch.

6. A method for installing auxiliary equipment on a tractor-like vehicle, comprising the steps of:
identifying attachment points on a frame of the tractor-like vehicle for the installation of a bracket;
securing the bracket to the frame via fastening elements;
positioning a platform on the bracket to receive auxiliary equipment, wherein the auxiliary equipment is configured to extend the utility of the tractor-like vehicle for additional operational tasks.

7. The method of claim 6, further comprising the step of installing a first winch and a second winch on the platform positioned on the bracket, wherein each winch is equipped with a corresponding line for operational tasks.

8. The method of claim 6, wherein the corresponding lines of the first winch and the second winch are utilized in a dragline configuration to support dragging, lifting, and positioning of objects.

9. A system for enhancing land management and forest fire prevention capabilities of an excavator, wherein the excavator equipped with a boom, an arm/dipper, a bucket, and a cab, wherein the excavator is configured to perform standard excavation operations, the system comprising:
a bracket configured to be securely attachable to the frame of the excavator, wherein the bracket is configured to support auxiliary equipment without compromising the excavator's inherent functionalities;
auxiliary equipment mounted on the bracket, including a first winch and a second winch, each winch being equipped with a respective first line and second line for operational tasks; and,
wherein the boom of the excavator is adapted to facilitate a dragline configuration by providing an elevated point of attachment for the first and second lines, enabling the auxiliary equipment to extend the excavator's capabilities beyond excavation to include the dragging, lifting, and precise positioning of materials such as underbrush and debris, thereby leveraging the excavator's structural and operational characteristics to improve land management and contribute to forest fire prevention efforts.

10. The system of claim 9, wherein the first line of the first winch is configured to be anchored to a fixed location, providing a stable point of leverage that enhances the operational capacity of the dragline configuration, enabling more effective dragging, lifting, and positioning of materials by utilizing the fixed point to maximize control and force application during land management and forest fire prevention tasks.

11. The system of claim 10, further comprising the second line of the second winch being utilized as the dragline for the manipulation and movement of materials, and a dump block connected to the second line and the first line, facilitating the controlled positioning of materials.
